(19) United States
(12) Patent Application Publication
(10) Pub. No.: US 2026/0089195 A1
(43) Pub. Date: Mar. 26, 2026

(54) Artificial Intelligence (AI) agent intent classification and taxonomy management

(71) Applicant: Zscaler, Inc., San Jose, CA (US)

(72) Inventors: Hanchen Xiong, London (GB); Manikya Bardhan, Bengaluru (IN); Prakash Jagatheesan, San Jose, CA (US); Prasannakumar Jobigenahally Malleshaiah, San Jose, CA (US); Praveen Tiwari, Milpitas, CA (US); Raimi Shah, Austin, TX (US)

(73) Assignee: Zscaler, Inc., San Jose, CA (US)

(21) Appl. No.: 18/939,921

(22) Filed: Nov. 7, 2024

(30) Foreign Application Priority Data
Sep. 25, 2024 (IN) 202441072341

(51) Int. Cl. H04L 9/40

(52) U.S. Cl. CPC H04L 63/20; H04L 63/1425; H04L 63/1441

(57) ABSTRACT

Systems and methods for AI agent intent classification and taxonomy management include operating an Artificial Intelligence (AI) agent system that includes an agent core connected to memory, one or more tools, and a planner; providing the AI agent with a request; performing intent classification based on the request; and generating an answer to the request based on the intent classification. The intent taxonomy management can include, responsive to adding an intent, reviewing the one or more intents for ambiguity; generating one or more test cases for each of the one or more intents; running a regression test with the one or more test cases; checking for failure cases introduced by the one or more new intents; and providing one or more suggestions to edit the one or more new intents.

### FIELD OF THE DISCLOSURE

The present disclosure generally relates to machine learning, artificial intelligence, and cloud-based network security. More particularly, the present disclosure relates to systems and methods for Artificial Intelligence (AI) agent intent classification and taxonomy management.

### BACKGROUND OF THE DISCLOSURE

AI agent intent classification is a fundamental task in natural language processing (NLP) and conversational AI, designed to help systems understand and categorize user input into actionable goals. As conversational agents, such as chatbots and virtual assistants, have become more integrated into everyday life, accurately identifying user intent has become crucial for providing relevant and effective responses. The development of intent classification stems from the need to translate natural human language into structured tasks that AI agents can process. Early systems relied on rule-based approaches, where specific keywords or patterns were matched to predefined actions. However, this approach struggled with the complexity and variability of natural language, making it difficult to handle diverse queries and more nuanced requests. Based thereon, the present disclosure presents a novel approach for AI agent intent classification and taxonomy management. The methods described herein leverage LLM-based processes for optimizing the intent classification and management pipeline.

### BRIEF SUMMARY OF THE DISCLOSURE

The present disclosure relates to systems and methods for Artificial Intelligence (AI) agent intent classification and taxonomy management. AI agents provide a way to link LLMs with backend systems. An AI Agent encompasses a system that employs an LLM to process and reason about a specific domain. To generate specific answers (often related to the domain), the AI Agent leverages auxiliary systems in conjunction with the LLM. These auxiliary systems support the agent in comprehending the domain and facilitating the creation of accurate responses. AI Agents can include four major components. The agent core forms the central component and is responsible for orchestrating the agent's overall functionality. The memory module enables the agent to store and retrieve relevant information, enhancing its ability to retain context and make informed decisions. The planner component guides the agent's actions by formulating a strategic course of actions based on the given problem or task. Finally, the set of tools encompasses various external components and resources that assist the agent in performing specific tasks or functions within the defined domain. These components collaboratively enable AI Agents to effectively process information, reason, and generate responses in a manner aligned with their designated purpose.

The present disclosure includes methods having steps, processing devices configured to implement the steps, a cloud-based system configured to implement the steps, and as a non-transitory computer-readable medium storing instructions for programming one or more processors to execute the steps. In various embodiments, the steps include operating an Artificial Intelligence (AI) agent system that includes an agent core connected to memory, one or more tools, and a planner; providing the AI agent with a request; performing intent classification based on the request; and generating an answer to the request based on the intent classification.

The steps can further include selecting an intent for the request based on a plurality of intents. The selecting can be based on a plurality of priority levels, wherein each of the plurality of priority levels includes one or more intents therein. The selecting can include performing a parallel intent classification for each of the plurality of priority levels and selecting a best intent from each of the plurality of priority levels; and selecting a final intent from the best intents and generating an answer to the request based thereon. The steps can further include prior to operating the AI agent, building an intent database, the intent database including a plurality of intents for the AI agent to utilize when generating answers to requests. Generating the intent database can include adding one or more intents to the intent database, wherein the steps further include reviewing the one or more intents for ambiguity; generating one or more test cases for each of the one or more intents; running a regression test with the one or more test cases; checking for failure cases introduced by the one or more new intents; and providing one or more suggestions to edit the one or more new intents. The steps can be automatically performed by a Large Language Model (LLM) responsive to a new intent being provided.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a block diagram of an AI agent.

FIG. 6 is a logical diagram of an AI platform that can provide AI functionality with one or more cloud services.

FIG. 7 is a logical diagram of an example AI copilot system, which utilizes the AI agents of FIG. 5 and the AI platform of FIG. 6.

FIG. 8 is a flow diagram of functionality in the AI copilot system of FIG. 7, in the example use case of user monitoring.

FIG. 9 is a flowchart of an AI agent process.

FIG. 10 is a flow diagram of an intent classification pipeline for an AI agent.

FIG. 11 shows a plurality of intents categorized within various priority levels.

FIG. 12 is a flow diagram depicting an example logic for intent classification.

FIG. 13 is a flow diagram depicting a parallel intent generation process.

FIG. 14 is a flow diagram of a Continuous Integration/Continuous Deployment (CI/CD) processes for intent taxonomy management.

FIG. 15 is a flowchart of a process for LLM-based intent classification and taxonomy management.

### DETAILED DESCRIPTION OF THE DISCLOSURE

Again, the present disclosure provides an AI agent intent classification and intent management framework. The methods described herein include steps for optimized intent classification which leverage parallel intent determinations across a plurality of intent priority levels. Further, various methods include optimized intent taxonomy management which leverages an LLM-based process for altering an intent database and ensuring that alterations do not negatively impact the performance of the intent classification.

### Cybersecurity Monitoring and Protection Examples

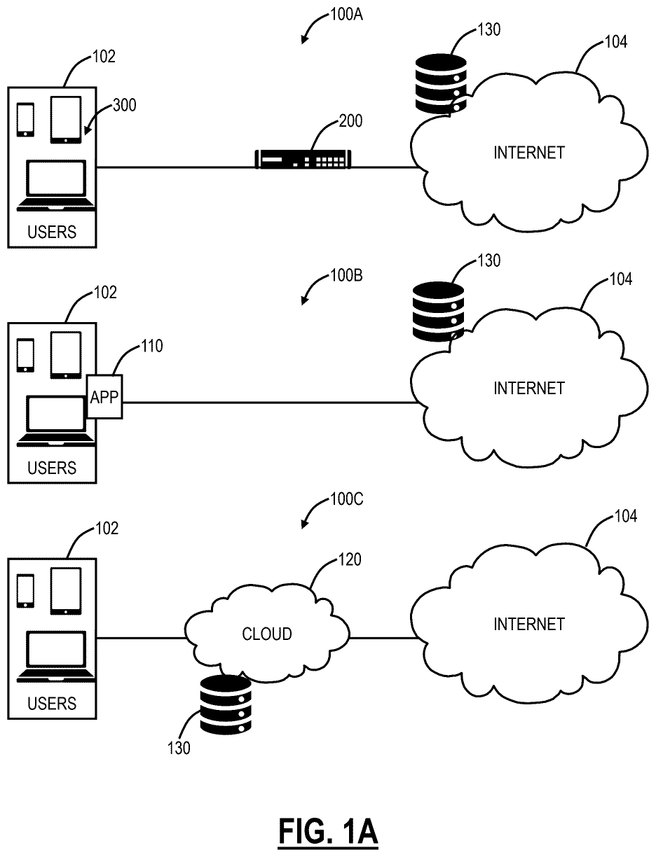

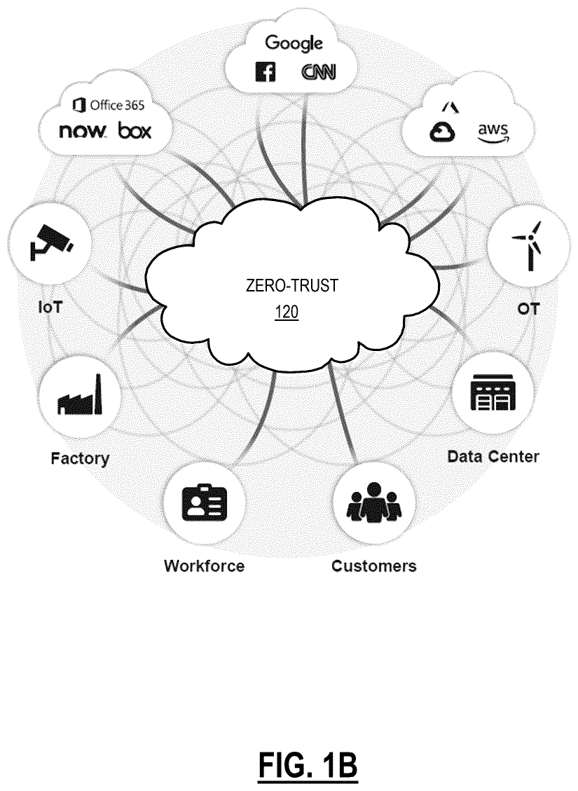

FIG. 1A is a network diagram of three example network configurations 100A, 1001B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

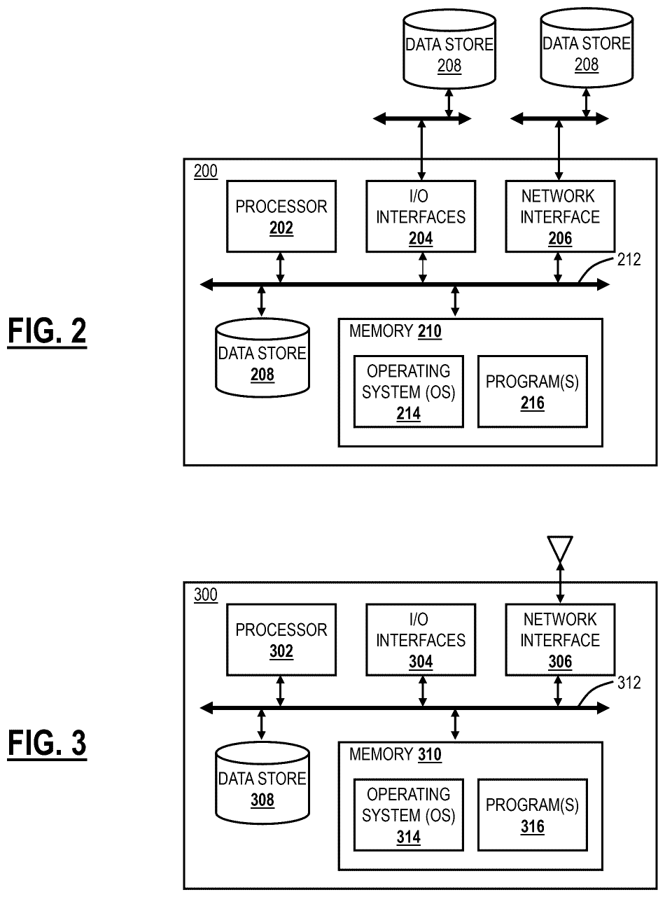

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM), such as DRAM, SRAM, SDRAM, and the like), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc . . . .

### Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (loT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 1001B). Of course, various embodiments are contemplated herein, including combinations of the network configurations 100A, 100B, 100C together. For example, the application 110 can perform similar functionality as the cloud 120, as well as coordinated functionality with the cloud 120.

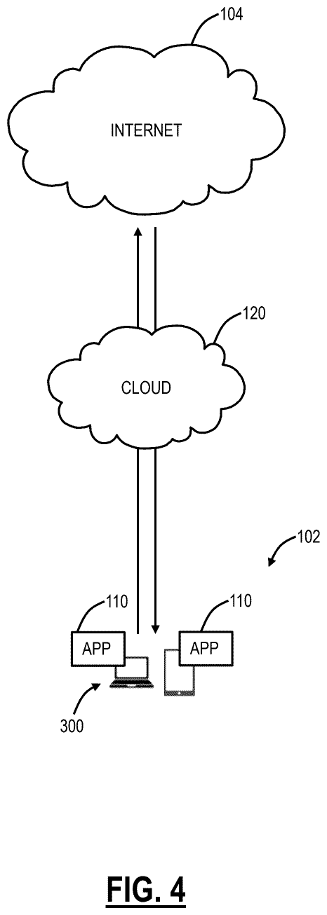

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### AI Agents

Again, the present disclosure relates to systems and methods for next generation AI agents for end users. In this disclosure, we examine the role of AI agents as a way to link LLMs with backend systems. Then, we look at how the use of intuitive, interactive semantics to comprehend user intent can set up AI agents as the next generation user interface and user experience (UI/UX). Finally, with upcoming AI agents in software, we show why we need to bring back some principles of software engineering that people seem to have forgotten in the past few months.

The next generation AI agents described herein can be used as a copilot for cloud services, including cybersecurity services. Some specific areas include:

TABLE 1
Generative AI feature and Software-as-a-Service (SaaS) procurement.
Use Case evaluation and Return on Investment (ROI) evaluation.
Project Portfolio Management.
Perform exploratory data analysis to understand ecosystems, behavioral trends, and long-
term trends.
Build machine learning models (training, validation, and testing) with appropriate solutions
for data reduction, sampling, feature selection, and feature engineering.
Design and evaluate experiments (including hypothesis testing) by creating key data sets.
Apply data mining or NLP techniques to cleanse and prepare large data sets.
Defining and socializing best practices.
Regularly measure analytics.
Create and maintain production models and related applications.
Develop enterprise Advanced Analytics, AI/ML as a service and MLOps strategy.
Develop Data Platform enhancements or vendor selection requirements for AI/ML
workbench/platform.
Improve predictive models with data from multiple models.
Automate feedback loops for algorithms/models in production.
Create repeatable processes and scalable data products.
Influence functional teams and develop best practices across the organization.
Review, scale, and enhance operationalized statistical models and algorithms.
Empower end users to debug and resolve issues with their devices through conversational
assistance.
Other use cases include, but are not limited to: account scoring, propensity to buy,
customer segmentation, sentiment analysis, customer churn and uplift prediction,
hypothesis testing and forecasting models.

LLMs offer a more intuitive, streamlined approach to UI/UX interactions compared to traditional point-and-click methods. Seemingly straightforward requests can trigger a series of complex interactions in applications, potentially spanning several minutes of interactions using normal UI/UX. For example, one would probably have to choose a category, perform searches, perform checks, and then potentially find an answer.

We Need More than LLMs

LLMs are AI models trained on vast amounts of textual data, enabling them to understand and generate remarkably accurate human-like language. Models such as OpenAI's GPT-3 have demonstrated exceptional abilities in natural language processing, text completion, and even generating coherent and contextually relevant responses.

Although more recent LLMs can do data analysis, summary, and representation, the ability to connect external data sources, algorithms, and specialized interfaces to an LLM gives it even more flexibility. This can enable it to perform tasks that involve analysis of domain-specific real-time data, as well as open the door to tasks not yet possible with today's LLMs.

Various examples illustrate the complexity of natural language processing (NLP) techniques. Even relatively simple requests necessitate connecting with multiple backend systems, such as databases, inventory management systems, tracking systems, and more. Each of these connections contributes to the successful execution of the order.

Furthermore, the connections required may vary depending on the request. The more flexibility one necessitates from the system, the more connections it needs with different backends. This flexibility and adaptability in establishing connections is crucial to accommodate diverse customer requests and ensure a seamless experience.

### AI Agents

LLMs serve as the foundation for AI agents. According to their definition, an AI agent is a sophisticated system that employs an LLM to process and reason about a specific domain. To generate an answer, the AI agent leverages auxiliary systems in conjunction with the LLM. These auxiliary systems support the agent in comprehending the domain and facilitating the creation of accurate responses.

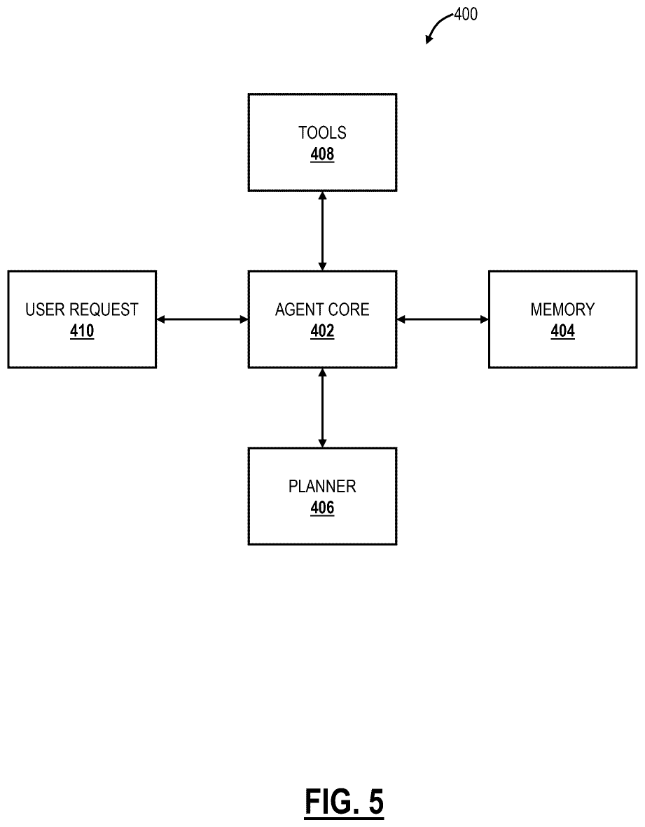

FIG. 5 is a block diagram of an AI agent 400. The AI agent 400 includes several integral components or modules, such as an agent core 402, a memory module 404, a planner component 406, tools 408, and a user request 410. Note, these components or modules 402, 404, 406, 408, 410 are implemented via compute resources. The agent core 402 forms the central component and is responsible for orchestrating the agent's 400 overall functionality. The memory module 404 enables the agent 400 to store and retrieve relevant information, enhancing its ability to retain context and make informed decisions. The planner component 406 guides the agent's 400 actions by formulating a strategic course of action based on the given problem or task. Various additional tools 408 and resources assist the agent in performing specific tasks or functions within the defined domain. The user request 410 provides the UI/UX interface to the agent 400. These components collaboratively enable AI agents 400 to effectively process information, reason, and generate responses in a manner aligned with their designated purpose.

### Agent Core

The agent core 402 plays a central role in orchestrating the AI agent's 400 overall functionality. It serves as the control center, managing decision-making processes, communication, and coordination of various modules and subsystems within the agent 400. The primary function of the agent core 402 is to facilitate the seamless operation of the AI agent 400 and ensure efficient interaction with the environment or the tasks at hand.

The agent core 402 acts as the interface between the AI agent 400 and its surroundings. It receives inputs from the environment or external systems, processes the information, and generates appropriate actions or responses. This involves employing various algorithms, heuristics, or decision-making mechanisms to analyze the received data and determine the best course of action. The agent core 402 also handles the coordination of different modules and subsystems within the AI agent 400, ensuring that they work in harmony to achieve the agent's 400 objectives.

Furthermore, the agent core 402 is responsible for managing the agent's 400 internal state. It maintains a representation of the agent's knowledge, beliefs, and intentions, allowing it to reason, plan, and adapt its behavior accordingly. The agent core 402 oversees the update and retrieval of information from the agent's 400 memory 404, enabling it to access relevant knowledge and contextual information during decision-making processes.

Overall, the agent core 402 acts as the brain of an AI agent 400, providing the intelligence, coordination, and control to enable the agent 400 to effectively interact with the environment and perform tasks within the defined domain. It governs the decision-making, communication, and coordination processes, ensuring the agent 400 operates optimally and achieves its objectives.

### Memory

The memory module 404 encompasses two important aspects: history memory and context memory. These components work together to store and manage information critical to the agent's 400 operation, allowing it to make informed decisions and maintain a coherent understanding of the environment.

History memory serves as a repository for past interactions and experiences of the AI agent 400. It stores a record of previous inputs, outputs, and the outcomes of actions taken by the agent 400. This historical data enables the agent 400 to learn from past interactions and avoid repeating mistakes. By referring to the history memory, the agent 400 can gain insights into effective strategies, successful outcomes, and patterns in the data that can inform its decision-making process.

Context memory, on the other hand, focuses on maintaining a coherent understanding of the current situation. It stores relevant contextual information that provides the necessary background for the agent 400 to interpret and respond appropriately to the present state. This can include information about the environment, the user's preferences or intentions, and any other contextual factors that influence the agent's 400 behavior. By referencing the context memory, the agent 400 can adapt its actions and responses based on the specific circumstances, enhancing its ability to interact intelligently with the environment.

The integration of history memory and context memory allows the AI agent 400 to leverage both past experiences and current context to inform its decision-making process. By accessing historical data, the agent 400 can learn from its own actions and adjust its strategies accordingly. Simultaneously, the context memory ensures that the agent can adapt its behavior to the present situation, taking into account relevant contextual factors that may influence the decision-making process.

Overall, the memory module 404 serves as a crucial component for storing and managing information. By utilizing the stored data from past interactions and maintaining a coherent understanding of the current context, the agent 400 can make informed decisions, learn from experiences, and effectively navigate the complexities of its environment.

### Planner

The planner component 406 plays a crucial role in guiding the agent's 400 actions and formulating a strategic course of action based on the given problem or task. It is responsible for generating a sequence of steps or actions that lead the agent 400 towards achieving its objectives.

The planner component 406 analyzes the current state of the environment, along with any available information or constraints, to determine the most effective sequence of actions to achieve the desired outcome. It considers factors such as goals, resources, rules, and dependencies to generate a plan that optimizes the agent's 400 decision-making process.

An example of a prompt template that can be used by the planner is as follows.

GENERAL INSTRUCTIONS
You are a domain expert. Your task is to break down a complex question into
simpler sub-parts. If you cannot answer the question, request a helper or use a tool.
Fill with Nil where no tool or helper is required.
AVAILABLE TOOLS
- Search Tool
- Math Tool
CONTEXTUAL INFORMATION
<information from Memory to help LLM to figure out the context around question>
USER QUESTION
“How to order a margherita pizza in 20 min in my app?”
ANSWER FORMAT
{“sub-questions”:[“<FILL>”]}

The planner component 406 would then utilize this prompt template to generate a plan that outlines specific actions and steps to be taken.

By employing the planner component 406, the AI agent 400 can systematically determine the optimal sequence of actions to achieve its objectives, ensuring efficient decision-making and effective utilization of available resources. The generated plan serves as a roadmap for the agent's 400 actions, enabling it to navigate complex problem spaces and accomplish its goals in a strategic manner.

### Tools

In the AI agent 400, the set of tools 408 encompasses various resources and functionalities that assist in performing specific tasks or functions within the defined domain. Here is a list of possible tools 408 that can be utilized in the AI agent 400:

(1) RAG (Retrieval-Augmented Generation): RAG is a tool that combines retrieval-based methods with generative language models. It enables the agent 400 to retrieve relevant information from a knowledge base and utilize it to generate coherent and contextually appropriate responses.

(2) Database connections: Connecting to databases allows the AI agent 400 to access and retrieve information from structured data sources. This tool enables the agent 400 to query and extract relevant data for decision-making or generating responses.

(3) Natural Language Processing (NLP) libraries: NLP libraries provide a range of tools and algorithms for processing and understanding human language. These libraries offer functionalities such as text tokenization, named entity recognition, sentiment analysis, and language modeling, which can enhance the agent's language processing capabilities.

(4) Machine Learning frameworks: Machine learning frameworks, such as TensorFlow or PyTorch, provide tools and algorithms for training and deploying machine learning models. These frameworks enable the agent 400 to leverage various machine learning techniques, including supervised learning, unsupervised learning, or reinforcement learning, to enhance its capabilities.

(5) Visualization tools: Visualization tools assist in representing and interpreting data or model outputs in a visual format. These tools can help the agent 400 understand complex patterns, relationships, or trends in the data, aiding in decision-making and analysis.

(6) Simulation environments: Simulation environments provide a controlled virtual environment where the AI agent 400 can interact and learn without impacting the real world. These tools allow the agent to practice and refine its skills, test different strategies, and evaluate the potential outcomes of its actions.

(7) Monitoring and logging frameworks: Monitoring and logging frameworks facilitate the tracking and recording of agent activities, performance metrics, or system events. These tools assist in evaluating the agent's 400 behavior, identifying potential issues or anomalies, and supporting debugging and analysis.

(8) Data preprocessing tools: Data preprocessing tools help in cleaning, transforming, and preparing raw data before feeding it into the AI agent 400. These tools may include techniques for data cleaning, normalization, feature selection, or dimensionality reduction, ensuring the quality and relevance of data used by the agent 400.

(9) Evaluation frameworks: Evaluation frameworks provide methodologies and metrics to assess the performance and effectiveness of the AI agent 400. These tools enable the agent to measure its success in achieving objectives, compare different approaches, and iterate on its capabilities.

These tools, among others, contribute to the AI agent's 400 toolkit, empowering it with specialized functionalities and resources to perform specific tasks, process data, make informed decisions, and enhance its overall capabilities in the defined domain.

### Bad Data

The cloud fulfilled the promise of not requiring data to be deleted, but just keeping data stored. With this, came the pressure to quickly create documentation for users. This created a “data dump”, where old data lives with new data, that old specifications that were never implemented are still alive, or even descriptions of functionalities of systems that have been outdated, but never updated in the documentation. Finally, documents seem to have forgotten what a “topic sentence” is, namely a sentence that expresses the main idea of the paragraph in which it occurs. Specifically, if we feed paragraphs into LLMs, we would like to extract the topic sentence.

LLM-based systems expect documentation to have well written pieces of text. Of note, OpenAI has stated that it is “impossible” to train AI without using copyrighted works. This alludes not only to the fact that we need a tremendous amount of text to train these models, but also that good quality text is required.

### RAG

This becomes even more important if you use RAG-based technologies (see Lewis, Patrick, et al. “Retrieval-augmented generation for knowledge-intensive NLP tasks.” Advances in Neural Information Processing Systems 33 (2020): 9459-9474, the contents of which are incorporated by reference in their entirety). In RAG, we index document chunks using embedding technologies in vector databases, and whenever a user asks a question, we return the top ranking documents to a generator LLM that in turn composes the answer. Needless to say, RAG technology requires well written indexed text to generate the answers.

RAG provides a pipeline which enables the combination of documents and algorithms in tools. In RAG, we index document chunks using embedding technologies in vector databases, and, whenever a user asks a question, we return the top ranking documents to a generator LLM that in turn composes the answer. Thus, RAG is the process of optimizing the output of an LLM, so it references an authoritative knowledge base outside of its training data sources before generating a response.

### Unified AI Agent Architecture for Cloud Services

Examples of cloud services include Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide cloud-based cybersecurity, namely Security-as-a-service through the cloud, including access control, policy enforcement, threat prevention, data protection, and the like. ZPA can include access control, segmentation, Zero Trust Network Access (ZTNA), etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs). Those of ordinary skill in the art will recognize various other types of cloud services are also contemplated.

The present disclosure addresses the application of using AI agents with cloud services, such as a copilot which is an AI assistant that allows a user to interact with the cloud service for a variety of tasks.

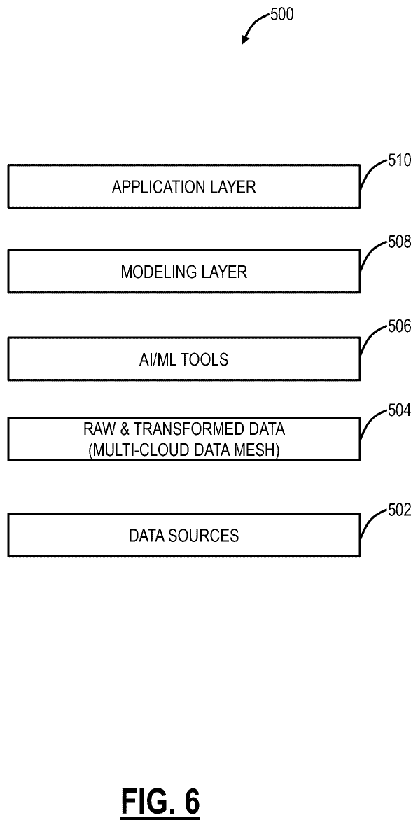

FIG. 6 is a logical diagram of an AI platform 500 that can provide AI functionality with one or more cloud services. The AI platform 500 can support multiple cloud services, such as for copilot functionality. The AI platform 500 is depicted in a logical manner in FIG. 6 and includes data sources 502, raw and transformed data 504, AI/ML tools 506, a modeling layer 508, and an application layer 510. The AI platform 500 can be realized as one or more AI agents 400, e.g., the application layer 510 can support the user request 410, the modeling layer 508 can be the agent core 402, the AI/ML tools 506 can be the tool 408, etc. The data sources 502 can include various data based on operations of the cloud services, product data, enterprise application data, third party data, web logs, other logs, and the like. The raw and transformed data 504 can include modified versions of the data in the data sources 502.

The AI platform 500, in an embodiment, can focus on providing model-based insights which help in understanding various aspects of business, customers, and products. In an embodiment, the AI platform 500 can provide generative AI Platform-as-a-Service. To start, various LLMs were used for providing functions related to cloud services. From this experience, it was determined that LLMs by themselves are not able to do much (in the sense that it hallucinates a lot), unless you fine tune it with your own data, fine tune it with instructions following capabilities (algorithms), connect to document sources to avoid hallucinations, or connect to data sources to enable better data analysis. That is, there is a need for AI agents 400, not merely LLMs.

The AI platform 500 is a unified foundation model for AI agents 400. The idea is that given a foundation model for an AI Agent, where any group willing to develop a new LLM project would only need to connect to it, and implement data connectors, documents, algorithms, and possibly fine tuning it.

### AI Platform as a Copilot for User Experience Monitoring

For illustration purposes, the AI agents 400 and the AI platform 500 are described with reference to a user experience monitoring service, such as ZDX available from Zscaler. In the traditional computing model, most users were centrally located under the control and monitoring of IT in an organization. The transformation of hybrid work, cloud, and zero trust has upended this approach. IT is no longer in control and the lack of visibility creates complexity in resolving issues. As such, there are Digital Experience Monitoring (DEM) services which provide visibility across devices, networks, and applications, even outside of IT control, for the detection and resolution of issues and their root causes.

Also, an AI copilot is a tool that can assist a user with a service. It is more helpful than a help guide in that it seeks to support a user in tasks and decision making, such as for context-aware assistance, automation of tasks, data analysis, communication, and the like. Importantly, an objective of a copilot is to reduce the requirement for user expertise. For example, in DEM, the AI copilot could provide answers as well as automate solutions, such as, “my Internet is slow, what should I do?” Those skilled in the art will appreciate the present disclosure contemplates the AI agents 400, the AI platform and the AI copilot in various use cases, i.e., DEM is shown for illustration purpose; other uses are contemplated.

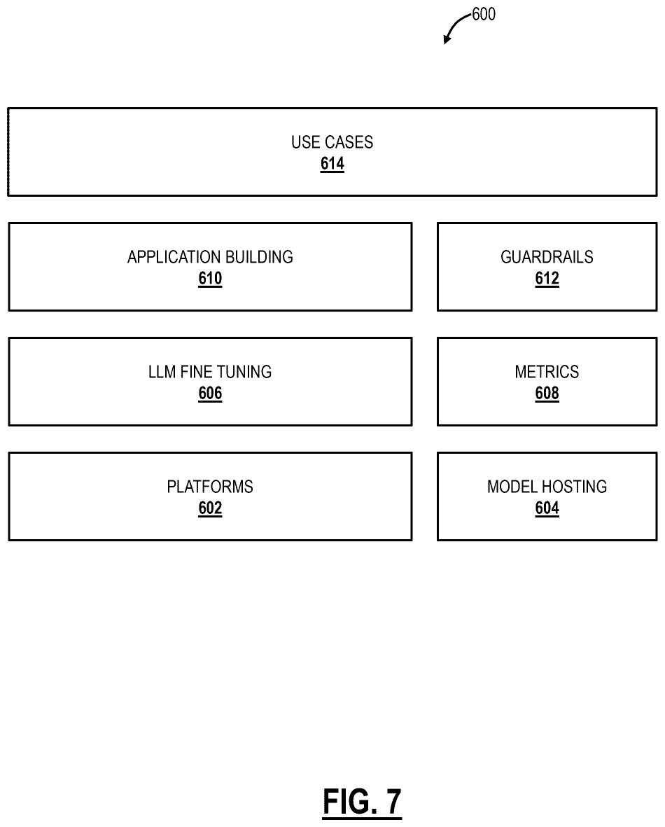

FIG. 7 is a logical diagram of an example AI copilot system 600, which utilizes the AI agents 400 and the AI platform 500. Those skilled in the art will appreciate FIGS. 5-7 are logical diagrams describing functionality. Of course, in implementation and realization, the functionality can be split up, combined, etc. with these FIGS. 5-7 presented as examples. The AI copilot system 600 includes a platform layer 602, a model hosting layer 604, an LLM fine tuning layer 606, metrics 608, an application building layer 610, guardrails 612, and various use cases 614 being serviced.

The platform layer 602 generally includes the compute resources and associated tools, hosting, etc., including commercial offerings as well as in-house developed environments. The model hosting layer 604 provides a servicing functionality to connect, launch, and generally service the models. The LLM fine tuning layer 606 includes LLMs, a fine tuners, training tools and data sets, and the like. The metrics 608 can include various measurement techniques to determine model effectiveness, from the LLM fine tuning layer 606, such as language metrics, ML metrics, alignment metrics, production metrics, etc. The application building layer 610 can include an orchestrator that manages different tools to build applications between the user cases 614 and the models being hosted below. The guardrails 612 ensure valid structure, safety, style, etc. Finally, the use cases 614 can be practically anything, such as assisting in DEM and the like.

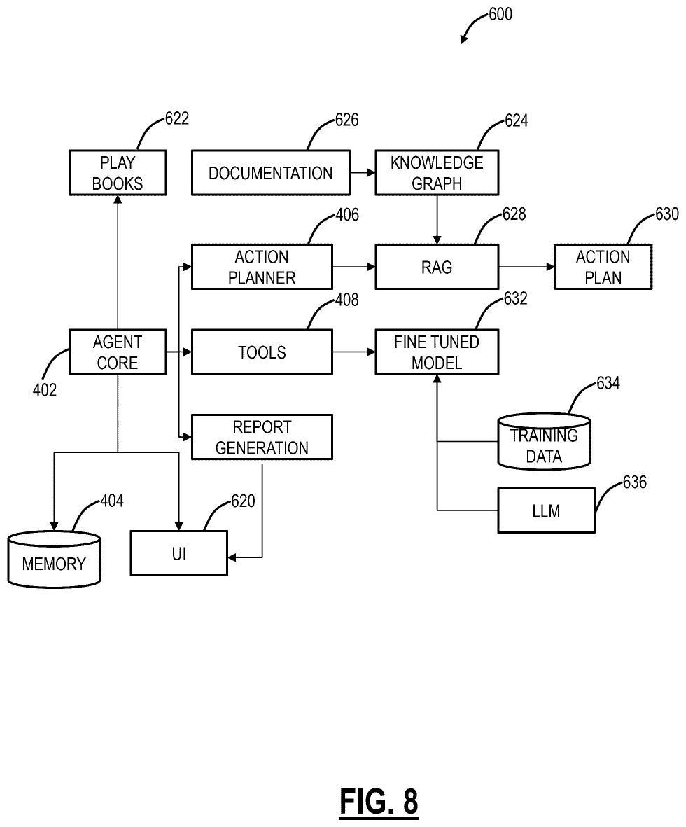

FIG. 8 is a flow diagram of functionality in the AI copilot system 600, in the example use case of user monitoring. FIG. 7 can be seen as a static view of the AI copilot system 600, where FIG. 8 presents a dynamic view, in the example use case of user monitoring. Do note, the AI copilot system 600 expands on the AI agents 400 and the AI platform 500, and includes the agent core 402, the memory 404, the planner 406, and the tools 408. Further, the AI copilot system 600 includes a user interface (UI) 620, playbooks 622, a knowledge graph 624 created from data such as documentation 626, a RAG 628 that develops an action plan 630 from the knowledge graph 624 and the planner 406, etc. The tools 408 include a fine tuning 632 component that can use training data 634 and other LLMs 636.

For the playbooks 622, sometimes, experts have already captured important complex scenarios that need to be executed. Because these playbooks involve complex scenarios that are extremely important to customers (user), we do not want to leave it to the planner to figure out how to execute this task, as we have seen that the accuracy of the planner can degrade exponentially as the number of sub-tasks increases.

For the graphs 624, words are connected to concepts, and, in an example user case of networking, cybersecurity is inferred from a network topology. So, it is important to increase accuracy of results by using concept and network topology graphs in order to better provide context to the planner so that it can perform good planning.

For the guardrails 612, recently a few papers showed that LLMs can leak out training data by asking questions in different ways (in fact, sometimes even simple questions can leak out training data). For example, we were able to get an example model to leak out training data by simply asking: Generate 100 questions similar to “I want to order a Margherita gourmet pizza in 20 minutes.” In addition to that, you want to avoid questions that are not relevant to the domain, bias, racism, and the like. In FIG. 8, the UI 620 can provide an interface for the user to interact, e.g., enter a query, etc., receive a report, action plan, etc.

### Example Operation

Assume a user uses the AI copilot system 600 for the following questions: What happens if I add policy a to my configuration? The following steps can be implemented by the AI copilot system 600:
1. A=retrieve current configuration
2. B=simulate configuration(A)
3. A′=add_policy_to_configuration(A, a)
4. B′=simulate configuration(A′)
5. C=compare(B, B′)
6. Report visualization of results(C)

### LLM is the New UI/UX

The acceleration of LLM model development and their visibility have prompted the genesis of many LLM-based products. Recently, the release of ChatGPT was a milestone that signaled a significant shift in society, including changes in software design paradigms. Initially, LLMs like ChatGPT revolutionized the field with advanced chatbots and AI Agents, enhancing the ability of these models by connecting data sources, algorithms and visualizations to LLMs.

However, there has been a transition towards more sophisticated systems such as Retrieval-Augmented Generation (RAG) and AI Agents. Although more recent LLMs have the capability to do data analysis and even data summarization and representation, the ability to connect to external data sources, algorithms and specialized interfaces to LLMs adds additional flexibility to LLMs by enabling it to perform tasks that involves analysis of domain specific real time data, or even the possibility to perform tasks that are still beyond LLM's capabilities.

Here, there is a discussion of the changes in software design using AI Agents, specifically, the shift from traditional UI/UX user stories in software design to LLM-based AI Agent interfaces implementing several user stories using a single natural language interface. This transition represents a paradigm shift from well-structured documentation of data sources, UI/UX interactions, and algorithms, where you can reasonably well estimate size and effort of development, to a more flexible, albeit imprecise, mode of interaction through natural language descriptions. While this shift has unlocked unprecedented levels of user accessibility and software adaptability, it has also introduced unique challenges. One of the most fundamental questions addressed herein is on how to estimate the development effort and size of these new systems, where the LLM interacts with the user sometimes in unknown ways.

### Next Generation AI Agent System

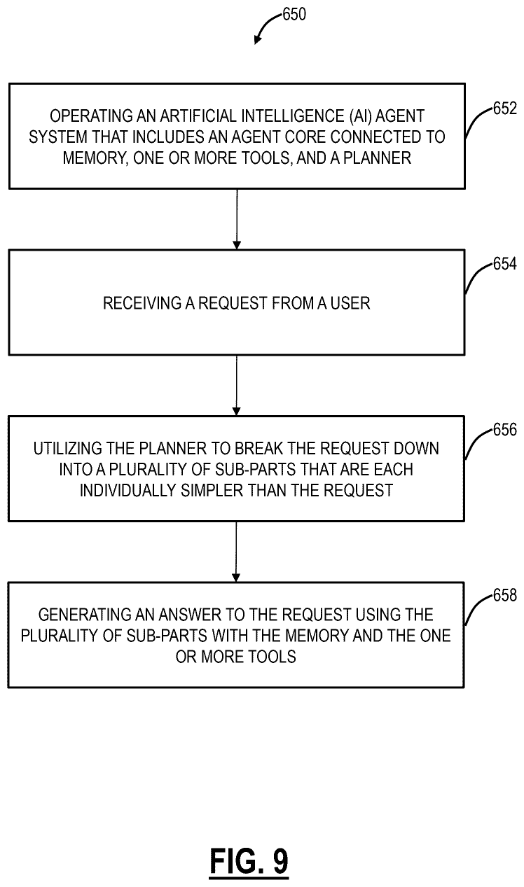

FIG. 9 is a flowchart of an AI agent process 650. The AI agent process 650 contemplates implementation as a method having steps, via a processing device configured to implement the steps, and as a non-transitory computer-readable medium storing instructions that, when executed, cause one or more processors to implement the steps.

The AI agent process 650 includes operating an Artificial Intelligence (AI) agent system that includes an agent core connected to memory, one or more tools, and a planner (step 652); receiving a request from a user (step 654); utilizing the planner to break the request down into a plurality of sub-parts that are each individually simpler than the request (step 656); and generating an answer to the request using the plurality of sub-parts with the memory and the one or more tools (step 658).

The agent core can be a first Large Language Model (LLM) and the planner is a second LLM, different from the first LLM. The memory can include a history memory and a context memory, with the history memory storing a record of previous inputs, outputs, and outcomes of actions taken by the AI agent, and the context memory includes relevant information about a current state. The one or more tools can be configured to perform specific functions based on a defined domain of the AI agent.

The one or more tools can include Retrieval-Augmented Generation (RAG). The RAG can include a plurality of questions and corresponding answers and a plurality of descriptions and corresponding algorithms, where a given answer is provide based on an associated questions and a given algorithm is performed based on an associated description. The agent core can be further configured to implement a given algorithm based on the answer matching the associated description.

The one or more tools can include one or more of a database connection, Natural Language Processing libraries, visualization tools, simulation environments, and monitoring frameworks. The planner can be configured to generate a plurality of related questions based on the request; and determine a plurality of algorithms, data sources, and user interface aspects, based on the plurality of related questions, and provide the plurality of algorithms, the data sources, and the user interface aspects to the agent core for orchestrating the answer. The AI agent system can operate as an assistant to one or more cloud services.

Further, the AI agent system can be adapted to help users troubleshoot issues relating to their devices. In various embodiments, the present methods include an AI agent that, upon authentication of a user, can help resolve device or network issues based on device and user specific data collected by the cloud based system described herein.

In another embodiment, a cloud system can be configured to implement the various functions described herein. Those skilled in the art will recognize a cloud service ultimately runs on one or more physical processing devices such as servers and computing devices, virtual machines, etc. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.”

### LLM-Based Intent Classification and Taxonomy Management

Intent classification is a crucial task in Natural Language Understanding (NLU) for AI agents, particularly in conversational systems like chatbots or virtual assistants. It involves identifying the user's underlying goal or intention based on their input, typically in the form of text. When a user interacts with an AI agent, such as asking a question, the AI processes the input and determines what action the user wants to perform. These inputs are mapped to predefined intents that represent the user's desired action.

Traditionally, to achieve this, intent classification relies on labeled training data that links specific user queries with corresponding intents. The system extracts linguistic features, such as keywords, phrases, and contextual information, from the user's input to help identify the correct intent. Challenges such as ambiguous queries or out-of-scope requests can arise. For instance, a query of “Can you tell me the time?” might be interpreted as either asking for the current time or setting an alarm. AI agents must handle such ambiguity, and for queries that do not match any predefined intent, they should provide a graceful response, such as referring the user to human support or acknowledging the system's limitations. Intent classification is vital for enabling AI agents to understand and respond effectively to user inputs in a conversational context.

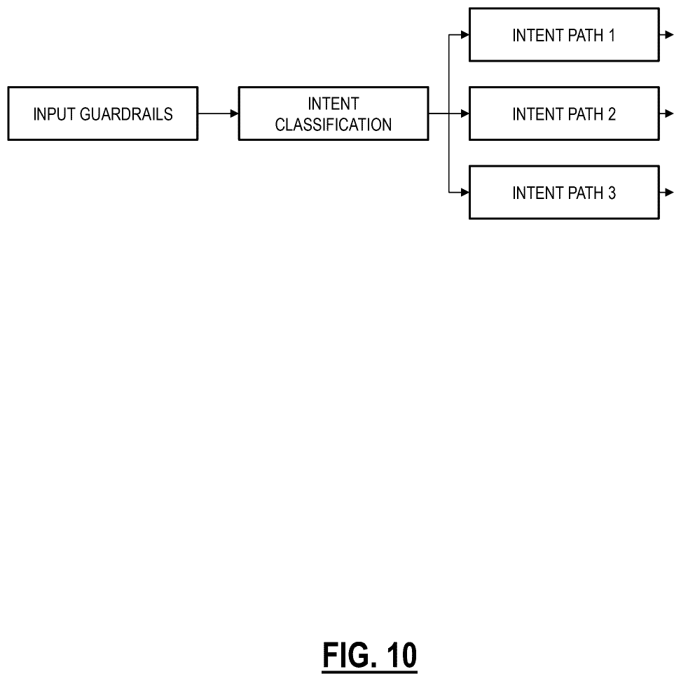

Intent classification is essential because it serves as the gateway to the entire conversational pipeline. If a user's query is incorrectly assigned to the wrong intent, it can significantly diminish the overall user experience, even if each intent is well-executed on its own. FIG. 10 is a flow diagram of an example intent classification pipeline for an AI agent.

There can exist a plurality of types of intent taxonomy. For example, these taxonomy methods can include hierarchical and flat taxonomy types. for AI agents, it is typical to see hierarchical intent taxonomy. That is, there could be a meta intent “troubleshooting”, under which there are more granular intentions. For example, under the meta intent of “troubleshooting”, there could be various granular intentions of “Wi-Fi Troubleshooting”, “Device Troubleshooting”, “Application Troubleshooting”, and the like. Alternatively, flat intent taxonomy is a structure which organizes leaf-level intents into a flat structure and therefore ignores intermediate meta intents.

Moreover, besides the taxonomy structure, it is also crucial to maintain a structured framework for individual intentions themselves. The following depicts an example of metadata for an intent called “user-ask-metrics”.

### Intent Name: User-Ask-Metrics

Intent Description: when a user wants any real-time information/data related to a specific ZDX metric. This data may be related to a particular application, user, or any such combination. Other various relevant but optional parameters include geolocation, device, time, and ISP.

Intent Scope: A metric must be asked for. This is the intent if the query asks for any metric regardless of its presence in the currently supported metrics list. If no specific metric is mentioned, the question intent is out of scope.

Positive Representatives: Can you show me the ZDX score for Zoom?

Negative Representatives: What metrics does Zscaler ZDX web probe provide?

As shown, an intent's metadata includes information to make itself self-explanatory and therefore differentiable from other intents. The information includes an Intent Name which is a unique name to represent each intent, an Intent Description which is a field that describes the representative context where the intent would be involved, and an Intent Scope which is a field that describes the intent's “territory” out of the whole question space. There are two subfields “Positive Representatives” and “Negative Representatives” to fine-tune the scope boundary to make it sharp and non-ambiguous. The Positive Representatives include a list of representative questions which belong to the intent, while the Negative Representatives include a list of questions that should not be considered as a question of the intent. Typically, some challenging and ambiguous negative questions (i.e. the negative examples which are close to the decision boundary) are included in the Negative Representatives.

In various situations, a certain degree of overlap or ambiguity always exists between intents. Therefore, some priority awareness needs to be considered when a question falls into an overlapping decision boundary between two intents. Such a prioritization policy can be employed based on various motives such as the fact that one intent may bring more value to users and should be prioritized, one intent may be recently added and needs to be promoted, one intent may potentially bring in more revenue and therefore should be triggered more often, and the like.

In reference to the AI agent for user experience monitoring described herein, there are flows and playbooks, and there is some overlap and ambiguity between a flow intent and a playbook intent. For example, for the user question “How bad was Zoom's performance yesterday?”, the user question may be interpreted as a plurality of different intents. In this example, this question may be interpreted as a Metric flow or a Troubleshooting playbook. For the Metric flow, the user may simply want to know the ZDX score of Zoom within yesterday's time window. For the Troubleshooting playbook, the user may be unhappy about Zoom's performance yesterday and wants to know more context about the issue. Such ambiguity is unavoidable if no other context is given within the user query. Based on current implementations, playbooks are preferred to flows, and therefore the Troubleshooting playbook is prioritized in this example case.

In another example, a user question/query may state “I would like to know the page fetch time of a team member”. This question could be interpreted as a Metric flow intent where the user would like to retrieve the page fetch time of a particular employee, or a General Q&A intent where the user may be relatively new to ZDX and would like to learn how to get the page fetch time. Again, such ambiguity is problematic if no other information is available. Based on priority policy, flows are preferred to General Q&A and therefore the Metric flow is prioritized to get picked.

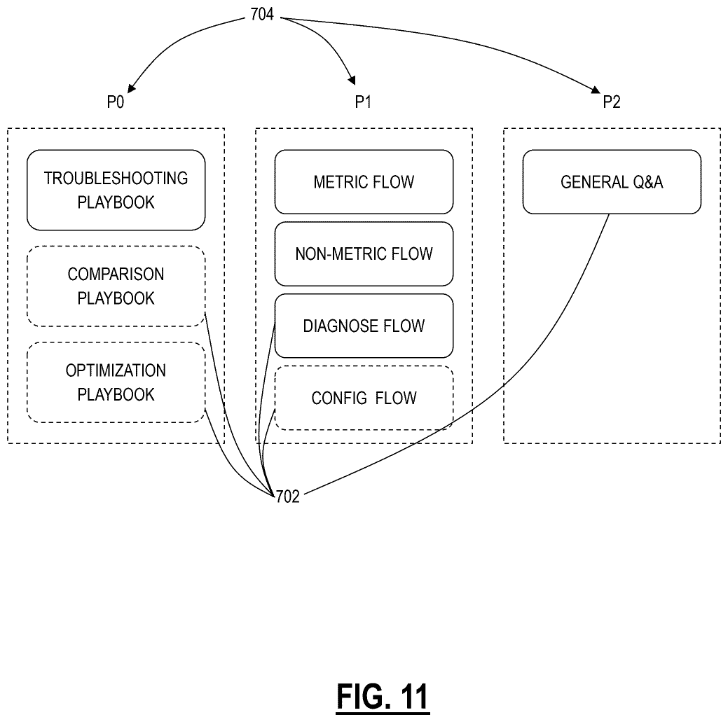

FIG. 11 shows a plurality of intents 702 categorized within various priority levels 704. Again, the present examples are associated with the described AI agent for user experience monitoring, although the present systems and methods can be utilized for any AI agent.

Traditionally, intent classification has been achieved by training a classifier to predict the intent classes of a user query. However, this conventional approach has several drawbacks. These drawbacks include a lack of pre-trained domain models, making it highly dependent on the quality of the training data; significant effort is required to maintain Machine Learning Operations (MLOps) pipeline, with the need to retrain the model whenever the intent taxonomy changes; and acquiring sufficient training data can be challenging, as poor data coverage increases the risk of overfitting.

Based on these challenges, the present disclosure provides a completely generative approach to perform intent classification. With the utilization of LLMs, many NLP tasks can be achieved via prompting, either with instruction or few-shot learning. The domain knowledge can be easily consumed and leveraged by injecting them into the prompts. In addition, LLMs are pre-trained with a vast language corpus and therefore there is no concern for overfitting. An example prompt used for LLM intent classification can include the following.

System Prompt: You are a helpful assistant to decide the intent of a user's question while using the ZDX AI agent. All the intents are listed below with their meta-information.

{{ intent_1_metadata }}
{{ intent_2_metadata }}
{{ intent_3_metadata }}

The generated intent should take into account the entire current conversation in case of follow up questions.

User Prompt: This is the conversation between the user and ZDX AI agent so far:

{{ conversation_history }}
And this is a new message from user:
{{ user_latest_message }}
Please pick an intent from {{ intent_name_list }}.

As can be seen, a notable instruction in the prompt is that the intent classification should take into account the conversation context. This is critical since there are some small and context-heavy engagements between users and AI agents. Using the message itself sometimes is not sufficient to decide the intentions.

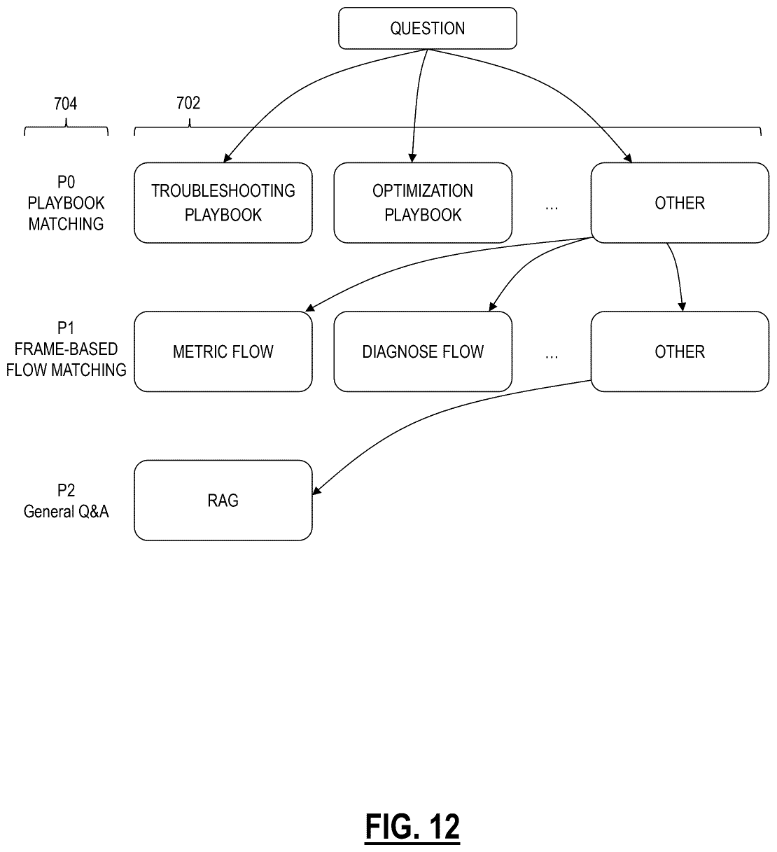

To add the priority awareness described herein, the system can implement a for-loop based logic to go through the intents from high priority to low priority. FIG. 12 is a flow diagram depicting an example logic for intent classification. In the approach shown in FIG. 12, there exists a sequential dependency. Such methods can introduce latency for lower level intents. For example, for the “General Q&A” question, hitting “RAG” intent would need to go through P0 and P1 level intent classification first. If there is no good match at P0 and P1, it then matches “RAG” intent. Further, there is limited visibility for intent taxonomy. For example, the LLM is not aware of any P1 “flow intents” while doing P0 “playbook” intent classification. Therefore, the likelihood of matching “other intent” will be biased since there could be a better match at a lower priority level.

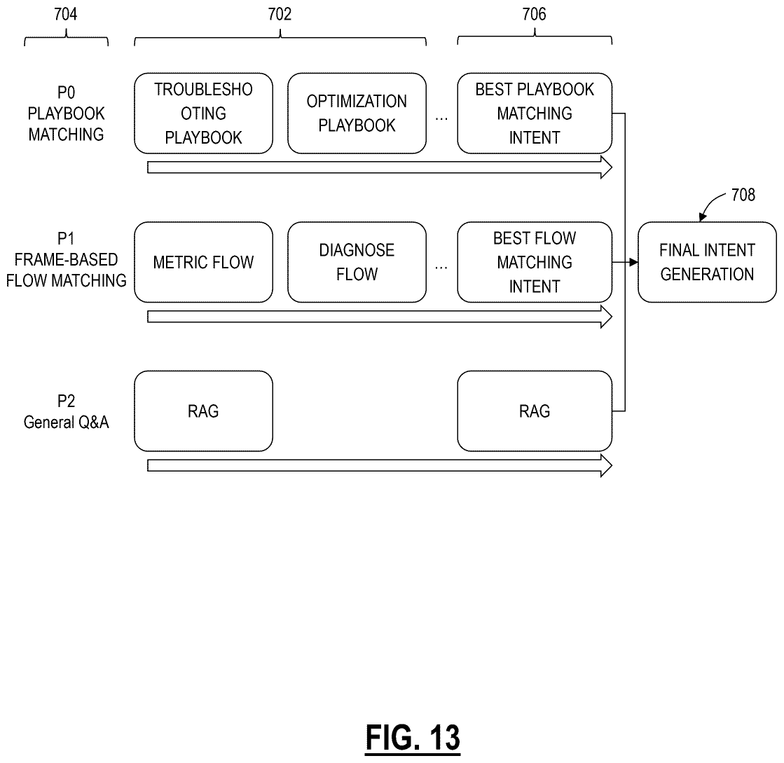

Various optimizations are introduced to overcome the issues described above. An optimized approach includes a performing a parallel level-wise intent classification to determine a best intent from each priority level 704, and once identified, determining a final “winner” out of all levels' candidates with priority awareness. FIG. 13 is a flow diagram depicting a parallel intent generation process. As described, for each priority level 704, a best intent 706 out of each intent 702 is determined in parallel. Once a best intent 706 is determined for each priority level 704, a final intent 708 is generated based on each of the best intents 706. Again, the intent classification processes described herein are LLM-based. By performing the intent classification as described, the intent classification process inherently includes awareness of each priority level. This increases accuracy as well as reducing latency.

Further, the present disclosure provides a Continuous Integration/Continuous Deployment (CI/CD) processes for intent taxonomy management. During development of AI agents, engineers must update intents and taxonomy. That is, throughout the development process, new intents may be added, intents may be deprecated, and intents may have their scope changed. Therefore, a CI/CD process is needed to ensure that any change in the intent metadata files will not break the existing intent classification and preserve the desired hierarchy. Based thereon, the present CI/CD process is presented as part of the intent classification framework.

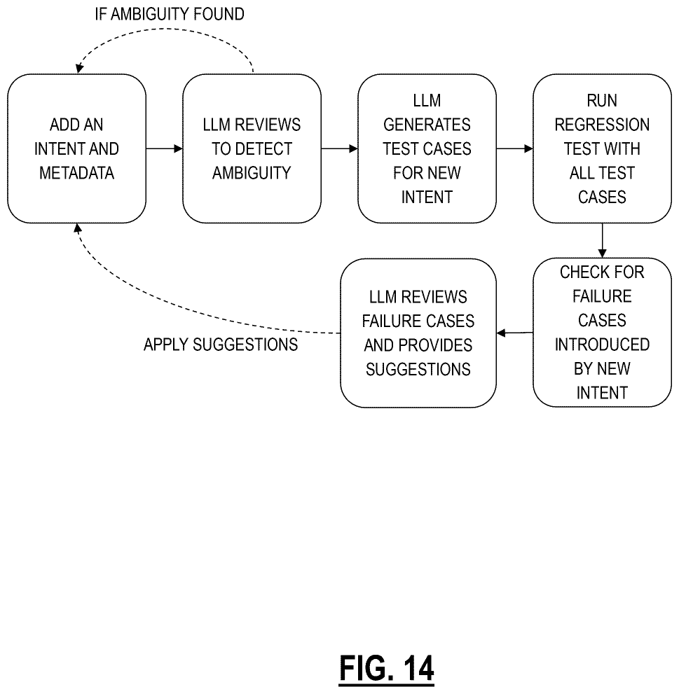

FIG. 14 is a flow diagram of a Continuous Integration/Continuous Deployment (CI/CD) processes for intent taxonomy management. FIG. 14 depicts an example flow of the CI/CD process when a new intent is added. It will be appreciated that a similar process will be followed when an existing intent is updated or deleted to ensure that any change in the intent metadata files will not break the existing intent classification and preserve the desired hierarchy. The whole process can be automated and orchestrated via a trained LLM with standard CI/CD pipelines. In the example shown in FIG. 14, when a new intent is added, a first step includes adding a new intent and its metadata. This step can include providing the LLM with the new intent and metadata. Based thereon, a next step, performed by the LLM, includes reviewing the new intent and its metadata for any ambiguity. If ambiguity is found, the new intent must be updated. Alternatively, a next step, also performed by the LLM, includes generating various test cases for the new intent. Based thereon, a next step includes running a regression test with the various test cases. A regression test is a type of software testing used to ensure that changes to a system, such as updates, bug fixes, or new features, do not unintentionally disrupt or degrade existing functionality. The goal of regression testing is to verify that the previously working parts of the software still function correctly after modifications. After running the regression test, the process includes checking for any failure cases introduced by the new intent. Based thereon a final step includes reviewing any failure cases with the LLM, and providing, via the LLM, any suggestions to edit the new intent to eliminate the failure cases. This process can be repeated after implementing any of the suggestions. The above described steps for intent taxonomy management can be used to generate an intent database for the AI agent to use in production.

Based on the described processes for intent classification and taxonomy management, AI agents can provide better responses to user requests. That is, based on receiving a user request, an intent can be optimally selected for providing a response to the user. Further, the intent classification process, and the various intents therein, can be managed via the intent taxonomy management processes described herein to ensure that possible intents are successfully covered and selected based on user queries.

### LLM-Based Intent Classification and Taxonomy Management Process

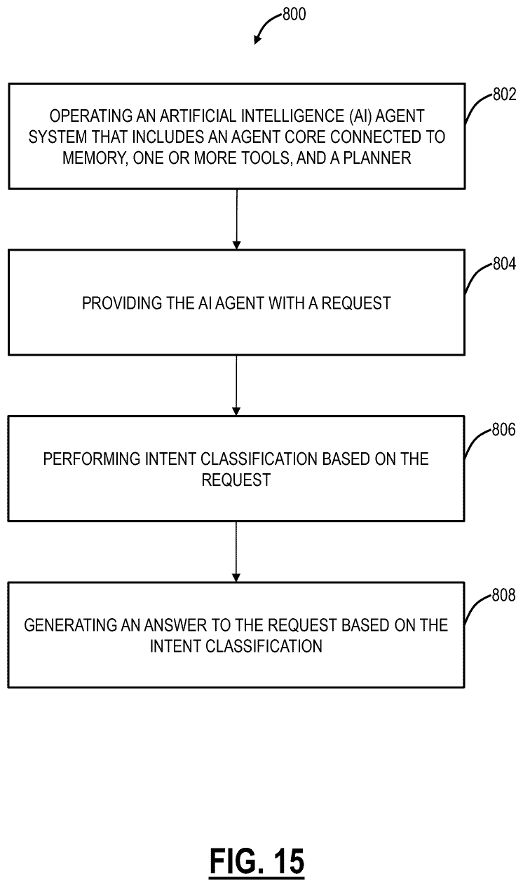

FIG. 15 is a flowchart of a process 800 for LLM-based intent classification and taxonomy management. The process 800 can be contemplated as a method having steps, processing devices configured to implement the steps, a cloud-based system configured to implement the steps, and as a non-transitory computer-readable medium storing instructions for programming one or more processors to execute the steps. The process 800 includes operating an Artificial Intelligence (AI) agent system that includes an agent core connected to memory, one or more tools, and a planner (step 802); providing the AI agent with a request (step 804); performing intent classification based on the request (step 806); and generating an answer to the request based on the intent classification (step 808).

The process 800 can further include selecting an intent for the request based on a plurality of intents. The selecting can be based on a plurality of priority levels, wherein each of the plurality of priority levels includes one or more intents therein. The selecting can include performing a parallel intent classification for each of the plurality of priority levels and selecting a best intent from each of the plurality of priority levels; and selecting a final intent from the best intents and generating an answer to the request based thereon. The steps can further include prior to operating the AI agent, building an intent database, the intent database including a plurality of intents for the AI agent to utilize when generating answers to requests. Generating the intent database can include adding one or more intents to the intent database, wherein the steps further include reviewing the one or more intents for ambiguity; generating one or more test cases for each of the one or more intents; running a regression test with the one or more test cases; checking for failure cases introduced by the one or more new intents; and providing one or more suggestions to edit the one or more new intents. The steps can be automatically performed by a Large Language Model (LLM) responsive to a new intent being provided.

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including software and/or firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” “a circuit configured to,” “one or more circuits configured to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Further, the various elements, operations, steps, methods, processes, algorithms, functions, techniques, modules, circuits, etc. described herein contemplate use in any and all combinations with one another, including individually as well as combinations of less than all of the various elements, operations, steps, methods, processes, algorithms, functions, techniques, modules, circuits, etc.

What is claimed is:

1. A method comprising steps of:
operating an Artificial Intelligence (AI) agent system that includes an agent core connected to memory, one or more tools, and a planner;
providing the AI agent with a request;
performing intent classification based on the request; and
generating an answer to the request based on the intent classification.

2. The method of claim 1, wherein the intent classification includes selecting an intent for the request based on a plurality of intents.

3. The method of claim 2, wherein the selecting is based on a plurality of priority levels, and wherein each of the plurality of priority levels includes one or more intents therein.

4. The method of claim 3, wherein the selecting comprises steps of:
performing a parallel intent classification for each of the plurality of priority levels and selecting a best intent from each of the plurality of priority levels; and
selecting a final intent from the best intents and generating an answer to the request based thereon.

5. The method of claim 1, wherein the steps further comprise:
prior to operating the AI agent, building an intent database, the intent database comprising a plurality of intents for the AI agent to utilize when generating answers to requests.

6. The method of claim 5, wherein generating the intent database comprises adding one or more new intents to the intent database, and wherein the steps further comprise:
reviewing the one or more new intents for ambiguity;
generating one or more test cases for each of the one or more new intents;
running a regression test with the one or more test cases;
checking for failure cases introduced by the one or more new intents; and
providing one or more suggestions to edit the one or more new intents.

7. The method of claim 6, wherein the steps are automatically performed by a Large Language Model (LLM) responsive to a new intent being provided.

8. A non-transitory computer-readable storage medium having computer-readable code stored thereon for programming one or more processors to perform steps of:
operating an Artificial Intelligence (AI) agent system that includes an agent core connected to memory, one or more tools, and a planner;
providing the AI agent with a request;
performing intent classification based on the request; and
generating an answer to the request based on the intent classification.

9. The non-transitory computer-readable storage medium of claim 8, wherein the intent classification includes selecting an intent for the request based on a plurality of intents.

10. The non-transitory computer-readable storage medium of claim 9, wherein the selecting is based on a plurality of priority levels, and wherein each of the plurality of priority levels includes one or more intents therein.

11. The non-transitory computer-readable storage medium of claim 10, wherein the selecting comprises steps of:
performing a parallel intent classification for each of the plurality of priority levels and selecting a best intent from each of the plurality of priority levels; and
selecting a final intent from the best intents and generating an answer to the request based thereon.

12. The non-transitory computer-readable storage medium of claim 8, wherein the steps further comprise:
prior to operating the AI agent, building an intent database, the intent database comprising a plurality of intents for the AI agent to utilize when generating answers to requests.

13. The non-transitory computer-readable storage medium of claim 12, wherein generating the intent database comprises adding one or more new intents to the intent database, and wherein the steps further comprise:
reviewing the one or more new intents for ambiguity;
generating one or more test cases for each of the one or more new intents;
running a regression test with the one or more test cases;
checking for failure cases introduced by the one or more new intents; and
providing one or more suggestions to edit the one or more new intents.

14. The non-transitory computer-readable storage medium of claim 13, wherein the steps are automatically performed by a Large Language Model (LLM) responsive to a new intent being provided.

15. A cloud-based system comprising:
one or more processors; and
memory storing computer-executable instructions that, when executed, cause the one or more processors to:
operate an Artificial Intelligence (AI) agent system that includes an agent core connected to memory, one or more tools, and a planner;
provide the AI agent with a request;
perform intent classification based on the request; and
generate an answer to the request based on the intent classification.

16. The cloud-based system of claim 15, wherein the intent classification includes selecting an intent for the request based on a plurality of intents.

17. The cloud-based system of claim 16, wherein the selecting is based on a plurality of priority levels, and wherein each of the plurality of priority levels includes one or more intents therein.

18. The cloud-based system of claim 17, wherein the selecting comprises steps of:
performing a parallel intent classification for each of the plurality of priority levels and selecting a best intent from each of the plurality of priority levels; and
selecting a final intent from the best intents and generating an answer to the request based thereon.

19. The cloud-based system of claim 15, wherein the instructions, when executed, further cause the one or more processors to:
prior to operating the AI agent, build an intent database, the intent database comprising a plurality of intents for the AI agent to utilize when generating answers to requests.

20. The cloud-based system of claim 19, wherein generating the intent database comprises adding one or more new intents to the intent database, and wherein the instructions, when executed, further cause the one or more processors to:
review the one or more new intents for ambiguity;
generate one or more test cases for each of the one or more new intents;
run a regression test with the one or more test cases;
check for failure cases introduced by the one or more new intents; and
provide one or more suggestions to edit the one or more new intents.
